(19) United States
(12) Patent Application Publication
(10) Pub. No.: US 2004/0033397 A1
(43) Pub. Date: Feb. 19, 2004

(54) Direct dimethoxymethane and methanol fuel cells

(75) Inventors: Kevin Colbow, West Vancouver (CA); Jiujun Zhang, Richmond (CA); Kyoung Bai, Cranbrook (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby, BC (CA)

(21) Appl. No.: 10/218,698

(22) Filed: Aug. 14, 2002

(51) Int. Cl. H01M 8/08

(52) U.S. Cl. 429/15; 429/30; 429/17

(57) ABSTRACT

Solid polymer fuel cells can operate directly on a fuel comprising a mixture of dimethoxymethane and methanol with both dimethoxymethane and methanol being oxidized at the fuel cell anode. Both being highly soluble in water, a dimethoxymethane and methanol mixture can be supplied as a liquid aqueous fuel solution. As a fuel, a dimethoxymethane and methanol mixture can provide similar power characteristics as methanol in liquid feed solid polymer fuel cells and is found to outperform methanol at high current densities. Additionally, dimethoxymethane acts as a reactive antifreeze additive in the fuel mixture and imparts a strong and distinct odor to the fuel mixture.

### BACKGROUND OF THE INVENTION

1. Field of the Invention

The present invention generally relates to fuel cells operating directly on fuel streams comprising a mixture of dimethoxymethane and methanol in which dimethoxymethane and methanol are directly oxidized at the anode and, more particularly, to solid polymer fuel cells operating directly on liquid fuel streams comprising a mixture of dimethoxymethane and methanol.

2. Description of the Related Art

Solid polymer electrochemical fuel cells convert reactants, namely fuel and oxidants, to generate electric power and reaction products. Electrochemical fuel cells generally employ an electrolyte disposed between two electrodes, namely a cathode and an anode. An electrocatalyst is needed to induce the desired electrochemical reactions at the electrodes. Solid polymer fuel cells operate in a range from about 80° C. to about 200° C. and are particularly preferred for portable and motive applications. Solid polymer fuel cells employ a membrane electrode assembly (MEA) which comprises a solid polymer electrolyte or ion-exchange membrane disposed between the two electrode layers. Flow field plates for directing the reactants across one surface of each electrode substrate are generally disposed on each side of the MEA. The electrocatalyst used may be a metal black, an alloy or a supported metal catalyst, for example, platinum on carbon. The electrocatalyst is typically incorporated at the electrode/electrolyte interfaces. This can be accomplished, for example, by depositing it on a porous electrically conductive sheet material, or “electrode substrate”, or on the membrane electrolyte.

Effective sites on the electrocatalyst are accessible to the reactant, are electrically connected to the fuel cell current collectors, and are ionically connected to the fuel cell electrolyte. Electrons, protons, and possibly other species are typically generated at the anode electrocatalyst. The electrolyte is typically a proton conductor, and protons generated at the anode electrocatalyst migrate through the electrolyte to the cathode.

A measure of electrochemical fuel cell performance is the voltage output from the cell for a given current density. Higher performance is associated with a higher voltage output for a given current density or higher current density for a given voltage output. Another measure of fuel cell performance is the Faradaic efficiency, which is the ratio of the actual output current to the total current associated with the consumption of fuel in the fuel cell. For various reasons, fuel can be consumed in fuel cells without generating an output current, such as when an oxygen bleed is used in the fuel stream (for removing carbon monoxide impurity) or when fuel crosses through a membrane electrolyte and reacts on the cathode instead. A higher Faradaic efficiency thus represents a more efficient use of fuel.

A broad range of reactants have been contemplated for use in electrochemical fuel cells, which reactants may be delivered in gaseous or liquid streams. The oxidant may, for example, be substantially pure oxygen or a dilute oxygen stream such as air. The fuel stream may be substantially pure hydrogen gas, a gaseous hydrogen-containing reformate stream derived from a suitable feedstock, or a suitable gaseous or liquid organic fuel mixture.

The choice of fuel may vary depending on the fuel cell application. Preferably, the fuel is relatively reactive electrochemically, inexpensive, easy to handle, and relatively safe for the environment. Hydrogen gas is a preferred fuel since it is electrochemically reactive and the by-products of the fuel cell reaction are simply heat and water. However, hydrogen can be more difficult to store and handle than other fuels or fuel feedstocks, particularly in non-stationary applications (e.g., portable or motive). For this reason, liquid fuels are preferred in many applications.

Fuel cell systems employing liquid fuels generally incorporate a reformer to generate hydrogen as required from a liquid feedstock that is easier to store and handle (e.g., methanol). However, the use of a reformer complicates the construction of the system and results in a substantial loss in system efficiency. To avoid using a separate reformer, fuels other than hydrogen may instead be used directly in fuel cells (i.e., supplied unreformed to the fuel cell anodes). Inside the fuel cell, a fuel mixture may be reacted electrochemically (directly oxidized) to generate electricity or instead it may first be reformed in-situ (internally reformed), as in certain high temperature fuel cells (e.g., solid oxide fuel cells). After being internally reformed, the fuel is then electrochemically converted to generate electricity. While such fuel cell systems may employ fuels that are easier to handle than hydrogen, and without the need for a separate reformer subsystem, generally hydrogen offers fundamental advantages with regard to performance and the environment. Thus, improvements in these areas are desirable in order for internally reforming and direct oxidation fuel cell systems to compete more favorably to hydrogen-based systems.

A direct methanol fuel cell (DMFC) is a type of direct oxidation fuel cell that has received much attention recently. A DMFC is generally a liquid feed solid polymer fuel cell that operates directly on an aqueous methanol fuel mixture. The anode and cathode reactions in a direct methanol fuel cell are shown in the following equations:

| | |
|---|---|
| Anode reaction: | CH₃OH + H₂O [symbol] 6H^{+ + CO}₂ + 6e⁻ |
| Cathode reaction: | 3/2O₂ + 6H⁺ + 6e⁻ [symbol] 3H₂O |
| Overall reaction: | CH₃OH + 3/2O₂ [symbol] CO₂ + 2H₂O |

There is often a problem in DMFCs with substantial crossover of methanol fuel from the anode to the cathode side through the membrane electrolyte. The methanol that crosses over then reacts with oxidant at the cathode and cannot be recovered, resulting in significant fuel inefficiency and deterioration in fuel cell performance. To reduce crossover, very dilute solutions of methanol (e.g., about 5% methanol in water) are typically used as fuel streams in DMFCs. Unfortunately, such dilute solutions afford only minimal protection against freezing during system shutdown in cold weather conditions, typically down to about −5° C.

Another problem encountered with DMFCs is related to the odorless nature of methanol. In order for users to detect the presence of the methanol fuel, as in the case of a fuel leak or spill, the methanol fuel should have a noticeable smell. Accordingly, for commercial applications it is desirable to add an additional component or additive to the aqueous methanol fuel to render the fuel detectable by its odor.

In published PCT WO 96/12317, alternative liquid fuels, including dimethoxymethane (DMM), trimethoxymethane, and trioxane, are disclosed for direct use in liquid feed solid polymer fuel cells. Like methanol, these fuels can be oxidized at the fuel cell anode to form carbon dioxide and water at a rate that provides satisfactory fuel cell performance. Methanol appears to be an intermediate product of the oxidation for each of these fuels.

DMM is available in quantity and may be synthesized from natural gas by conventional techniques. Furthermore, DMM is relatively nontoxic, compared to other fuels such as methanol, and has a strong and distinct odor. DMM is a liquid at room temperature and pressure and is fairly soluble in water. However, DMM has a low boiling point, 41° C., and accordingly difficulties may arise in attempting to use DMM as the sole fuel in a liquid feed fuel cell at temperatures higher than the boiling point.

More recently, published PCT WO 99/44253 discloses the use of dimethyl ether (DME) as a reactive antifreeze additive in the fuel supply of a liquid feed fuel cell, such as that of a DFMC. The performance of a fuel mixture of DME and methanol compared favorably to an aqueous methanol fuel solution at low current densities, however the performance of the fuel mixture was somewhat poorer at higher current densities.

Accordingly, there remains a need in the art for new and effective fuel mixtures that provide protection against freezing during system shutdown in cold weather conditions, are detectable by their odor and provide comparable performance to an aqueous methanol fuel solution. The present invention fulfills these needs and provides further related advantages.

### BRIEF SUMMARY OF THE INVENTION

It has been discovered that surprisingly good performance can be obtained from a fuel cell operating directly on a mixture of dimethoxymethane, (DMM), methanol and water wherein DMM and methanol are directly oxidized to generate protons at the anode electrocatalyst. Direct DMM/methanol solid polymer fuel cells can exhibit comparable performance to direct methanol fuel cells (DMFCs) and are found to outperform DMFCs at high current densities (i.e., greater than about 200 mA/cm²). Additionally, DMM has a desirably low freezing point and acts as a reactive antifreeze additive in the fuel mixture. Furthermore, DMM has a strong and distinct odor and, when present in a sufficient amount, imparts such an odor to the fuel mixture.

In a direct DMM/methanol fuel cell, a mixture of DMM, methanol and water is supplied directly to the fuel cell anode for direct oxidation therein. Accordingly, a direct DMM/methanol fuel cell system comprises a system for supplying a DMM/methanol/water mixture to the anode. The fuel stream may contain other reactants and may desirably be supplied as a liquid.

The efficiency of a direct DMM/methanol fuel cell system is generally improved by re-circulating any unreacted DMM, methanol and water back into the mixture supplied to the anode. Unreacted DMM, methanol and water are generally present in the anode exhaust, and may also be present in the cathode exhaust as a result of crossover through the electrolyte. A significant amount of product water is also generally present in the cathode exhaust. To re-circulate DMM, methanol and water from an electrode exhaust, a re-circulation loop can be employed that fluidly connects the electrode exhaust to a mixing apparatus inlet. A heat exchanger may be employed in the re-circulation loop to cool the fuel stream discharged from the electrode.

A representative embodiment of a system for directly supplying a mixture of DMM, methanol and water to a fuel cell system may additionally comprise a mixing apparatus for providing the mixture to the fuel cell. Mixing apparatus inlets may be fluidly connected to a DMM/methanol supply, a water supply and a re-circulation loop, while a mixing apparatus outlet may be fluidly connected to the anode of the fuel cell. Additionally, a sensor may be employed to monitor and control the concentration of methanol in the mixture and if the re-circulated DMM/methanol/water mixture contains a lower concentration of methanol than is desired in the mixture, the desired concentration can be prepared by suitably augmenting the mixture with fuel from DMM/methanol supply.

These and other aspects of the invention will be evident upon reference to the attached Figures and following detailed description. To that end, all documents cited herein are incorporated by reference in their entirety.

### BRIEF DESCRIPTION OF THE SEVERAL VIEWS OF THE DRAWING(S)

FIG. 1 shows a schematic diagram of a representative direct DMM/methanol solid polymer fuel cell system.

FIG. 2 shows a cyclic voltammetry curve for an aqueous solution of DMM in a voltage range of interest for fuel cell operation.

FIG. 3 shows polarization and power performance curves for a ten-cell direct liquid feed fuel cell stack employing fuel streams with three different DMM concentrations.

FIG. 4 compares polarization and power performance curves for a ten-cell direct liquid feed fuel cell stack employing fuel streams with varying DMM and methanol concentrations.

### DETAILED DESCRIPTION OF THE INVENTION

In one embodiment, a fuel cell system is disclosed that comprises a stack of solid polymer fuel cells operating directly on a mixture of dimethoxymethane (DMM) and methanol. DMM and methanol react directly with water at the fuel cell anodes to generate protons, electrons, and carbon dioxide. At the cathodes, the protons and electrons combine with oxygen to generate water. The fuel stream supplied to the anode thus comprises a suitable mixture of DMM, methanol and water. For volume efficiency, particularly for non-stationary applications, the fuel stream and/or its constituents may be stored in liquid form.

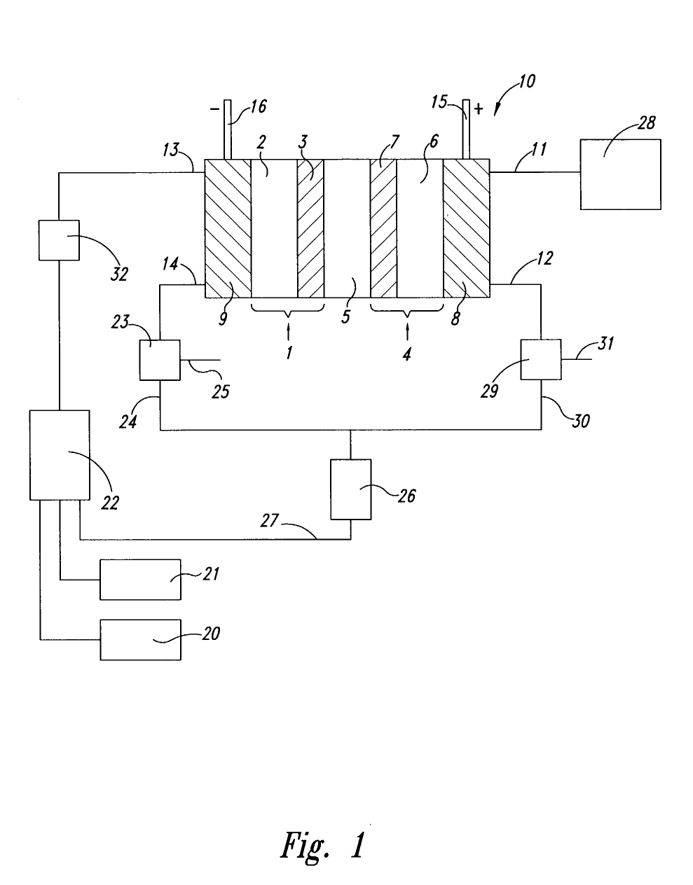

FIG. 1 shows a schematic diagram of a representative direct DMM/methanol solid polymer fuel cell system operating on a liquid fuel feed and employing exhaust re-circulation. For purposes of illustration, the stack is represented merely by a single liquid feed fuel cell 10 in FIG. 1. Fuel cell 10 contains a membrane electrode assembly (MEA) comprising a porous cathode 4 and porous anode 1 that are bonded to a solid polymer membrane electrolyte 5. The porous anode 1 typically comprises a carbonaceous substrate 2 and electrocatalyst layer 3. Proton conducting ionomer is preferably dispersed throughout the electrocatalyst layer 3 and optionally, the substrate 2. In a like manner, porous cathode 4 typically comprises a carbonaceous substrate 6 and electrocatalyst layer 7 with ionomer similarly dispersed throughout. Oxidant flow field 8 and liquid fuel flow field 9 are pressed against cathode substrate 6 and anode substrate 2 respectively on the faces opposite the membrane electrolyte 5. Fuel cell 10 has an oxidant inlet 11, an oxidant outlet 12, a liquid fuel stream inlet 13, and a liquid fuel stream outlet 14. Electrical power is obtained from the fuel cell via positive and negative terminals 15 and 16 respectively.

As shown in FIG. 1, the fuel stream is a DMM/methanol/water mixture derived from a DMM/methanol supply 20, a water supply 21, and a re-circulated DMM/methanol/water mixture from line 27. In alternate embodiments, water supply 21 may be omitted and water may instead be provided to the mixture either as an additional component in the DMM/methanol supply 20 or solely from product water in re-circulation line 27. Furthermore, the DMM/methanol supply 20 is provided at a desired concentration for fuel cell operation. A sensor 32 is employed in order to monitor and control the concentration of methanol in the fuel stream. If the re-circulated DMM/methanol/water mixture contains a lower concentration of methanol than is desired in the fuel stream, the desired concentration can be prepared by suitably augmenting the mixture with fuel from DMM/methanol supply 20. Accordingly, the concentration of DMM in the fuel stream may vary somewhat depending on the concentration of DMM in the re-circulated DMM/methanol/water mixture.

An advantage of the arrangement shown in FIG. 1 is that each of the DMM/methanol supply 20 and the re-circulated DMM/methanol/water mixture from line 27 comprise sufficient DMM in their respective fluids to provide protection against freezing in low temperature conditions and to impart an odor to the fuel mixture. Other arrangements may be utilized however depending on the specifics of system construction and operation. For example, separate DMM and methanol supplies may be employed if it is desirable to independently control the respective concentrations of DMM and methanol in the fuel stream.

Fluids from each of the DMM/methanol supply 20, water supply 21, and line 27 are supplied to inlets of mixing apparatus 22 in which the fluids are combined to form an appropriate fuel stream. The solubility of DMM in water is relatively high, as is the solubility of methanol in water. Accordingly, the fuel stream may contain a high concentration of fuel in order to obtain higher rates of reaction and to reduce the amount of water circulating through the anode. Suitable fuel mixtures contain 0.2 to 4.0 moles of methanol per liter of water and 0.05 moles to 15 moles of DMM per mole of methanol, and more particularly, 0.3 to 1.5 moles of methanol per liter of water and 0.2 moles to 4 moles of DMM per mole of methanol.

The fuel stream in FIG. 1 flows through fuel flow field 9 and the excess is then discharged to separator 23 where carbon dioxide reaction product may be separated from unreacted DMM, methanol and water in the fuel stream exhaust. Carbon dioxide may then be vented via line 25 while the unreacted DMM/methanol/water mixture may be re-circulated via line 24. A heat exchanger 26 may be employed to cool some or all of the re-circulating fluid stream.

The oxidant stream in FIG. 1 is provided by an air supply 28 and flows through oxidant flow field 8.

Under the above fuel stream conditions, and depending on the membrane 5, DMM and/or methanol may cross over to the cathode in otherwise conventional solid polymer fuel cell constructions. Any unreacted DMM and/or methanol at the cathode is desirably recovered and thus a re-circulation loop from the cathode exhaust may also be employed as shown in FIG. 1. Separator 29 may be used to separate oxygen and any carbon dioxide from DMM, methanol and water in the cathode exhaust. The former may be vented out line 31 while the latter may be re-circulated via line 30. Separator 29 may for example employ pressure swing absorption, water absorption, or membrane separation methods to accomplish such separation.

The complex electrochemical reactions that take place in a direct DMM/methanol solid polymer fuel cell are not completely understood. However, without being bound by theory, the following proposed reactions and discussions appear to match the observations to date.

At the anode:

X(CH₃OH+H₂O [symbol] 6H⁺+CO₂ +6e⁻) (1)

Y(CH₃OCH₂OCH₃+4H₂O [symbol] 16H⁺+3CO₂+16e⁻) (2)

At the cathode:

O₂+4H⁺+4e⁻ [symbol] 2H₂O (3)

The overall fuel cell reaction may be written as:

X(CH₃OH)+Y(CH₃OCH₂OCH₃)+(3/2X+4Y)O₂ [symbol] (X+3Y)CO₂+(2X+4Y)H₂O (4)

where X+Y=1.

In addition, DMM may first be adsorbed on the anode electrocatalyst surface at an elevated potential. The adsorbed fragment may then be attacked by a water molecule, leaving an adsorbed methanol fragment on the electrocatalyst and releasing a molecule of methanol. Both the fragment and the released methanol may then either be oxidized according to reaction (1) or, in the case of the latter, cross over to the cathode through the membrane.

The following examples have been included to illustrate different embodiments and aspects of the invention but these should not be construed as limiting in any way.

### EXAMPLE 1

### Electrochemical Test Cell

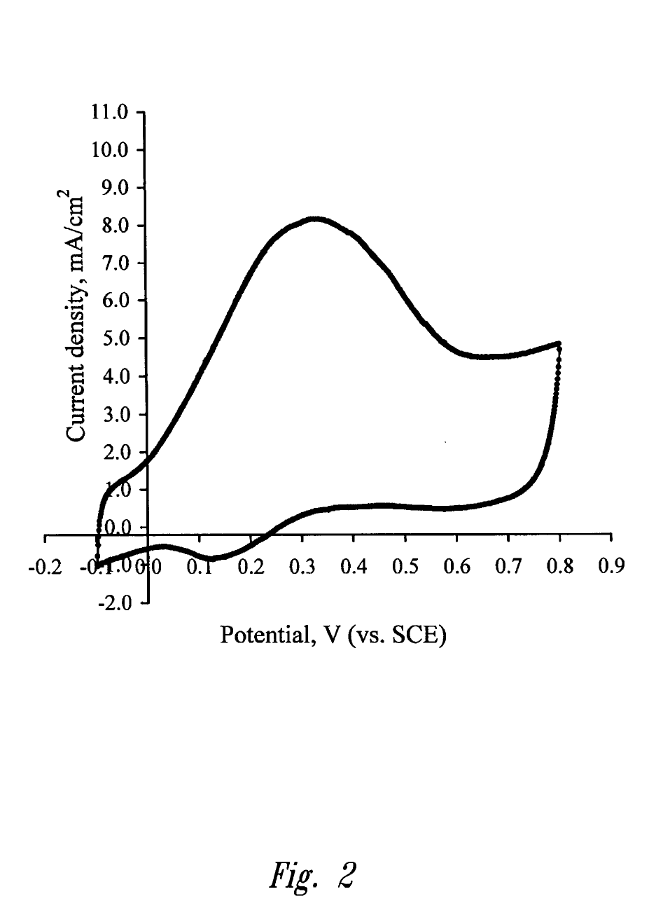

A cyclic voltammetry curve was obtained for an aqueous fuel solution of DMM in a voltage range of interest for fuel cell operation. Measurements were made in a test cell containing 0.1 M sulfuric acid at 60° C. at ambient pressure using three electrodes: a working graphite disk electrode (0.20 cm²) coated with Pt/Ru (atomic ratio 50/50) catalyst (Johnson Matthey, 0.2 mg/cm² loading); a counter Pt electrode; and a reference electrode (Saturated Calomel Electrode, abbreviated as SCE). The aqueous fuel solution was added to the acid electrolyte while the working electrode potential was controlled through a potentiostat and swept at 5 mV/s in the potential range of −0.1 V to 0.8 V (vs. SCE). FIG. 2 shows the results of cyclic voltammetry (current density as a function of voltage versus SCE) for 0.01 M DMM in water.

The aqueous DMM solution shows substantial activity during the sweep and accordingly, under the above conditions, DMM would be a suitable fuel for a direct oxidation fuel cell.

### EXAMPLE 2

### Fuel Test Cells

Solid polymer fuel cells were constructed and tested under varying conditions using aqueous DMM and aqueous DMM and methanol mixtures as the supplied fuel streams. Aqueous methanol fuel streams were also used for comparative purposes. In all cases, aqueous DMM and methanol solutions were prepared using analytical grade DMM and methanol and deionized water. Low pressure air was used as the oxidant.

A direct liquid feed fuel cell (DLFFC) stack was assembled from ten fuel cells comprising membrane and electrode assemblies (MEAs) in which the cathodes were prepared from TGP-H-060 (product of Toray) with 6% by weight PTFE binder, a 0.6 mg/cm² carbon base layer and a loading of 3.6 mg/cm² platinum black catalyst. The anodes were prepared from TGP-H-060 and contained 4.0 mg/cm² of Johnson Matthey Platinum/Ruthenium Black catalyst. The proton conducting membrane was NAFION® 115. The electrochemically active area for each membrane electrode assembly was 118 cm².

The stack was operated at 75° C. at ambient pressure and was supplied with reactants at ambient temperature (about 25° C.). Fluid flow rates were such that the oxidant stoichiometry was 3.

A. Fuel Test Cell Examples Using DMM Fuel

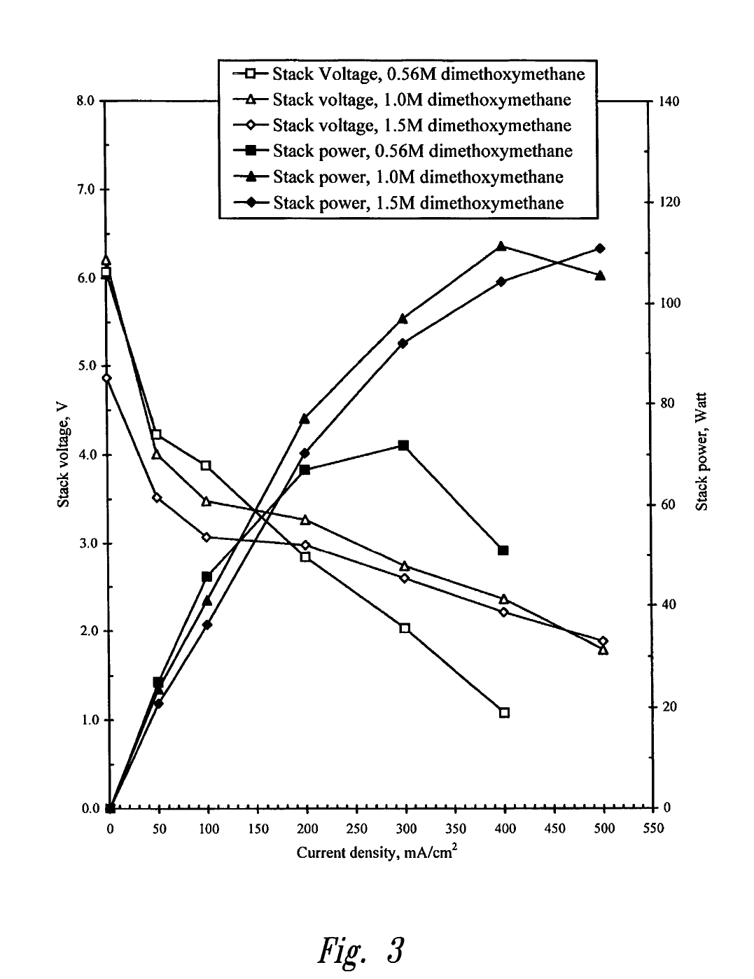

FIG. 3 shows polarization and power performance curves for the DLFFC stack described above employing fuel streams with three different DMM concentrations (i.e., 0.56 M, 1.0 M and 1.5 M) in the fuel inlet stream. In FIG. 3, the x-axis shows current density expressed in milliamperes per square centimeter. The left y-axis expresses stack voltage in volts and the right y-axis expresses stack power in watts.

Overall, it appears that a DLFFC stack employing the 1.0 M DMM fuel stream provides the best performance. In particular, at high current densities (i.e., greater than 150 mA/cm²), the operating voltage and power of a DLFFC stack employing the 1.0 M DMM fuel stream was higher than that of a DLFFC stack employing either a 0.56 M or 1.5 M DMM fuel stream.

B. Fuel Test Cell Examples Using a DMM/Methanol Fuel Mixture

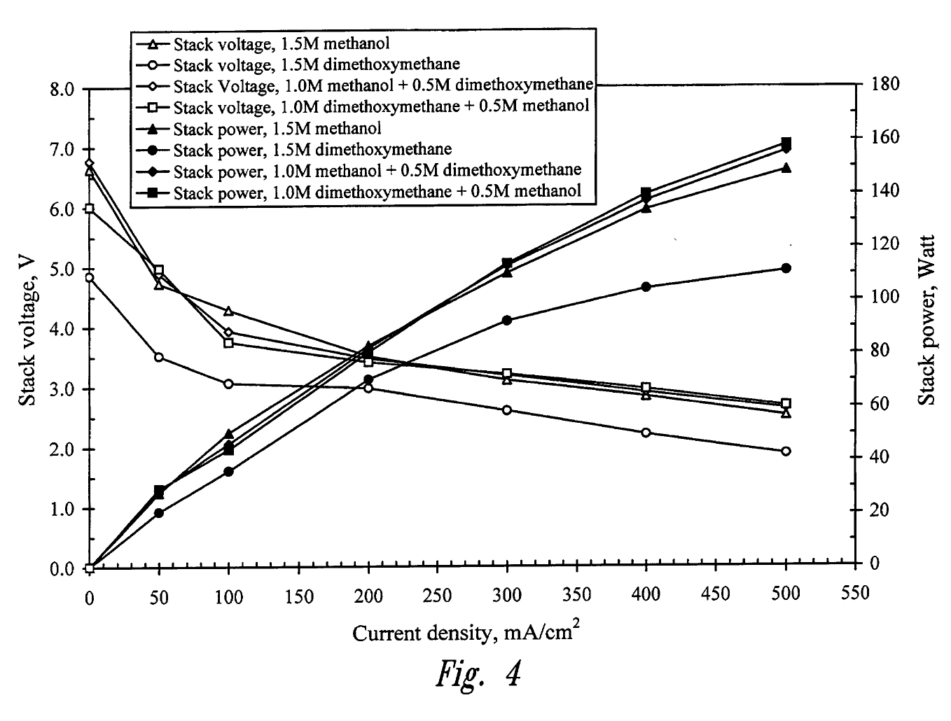

FIG. 4 compares polarization and power performance curves for the DLFFC stack described above employing fuel streams with varying DMM and methanol concentrations in the fuel inlet stream. In particular, the following fuel stream compositions were compared: a 1.5 M aqueous methanol solution; a 1.0 M DMM/0.5 M methanol aqueous solution (i.e. 2 moles of dimethyoxymethane per mole of methanol); a 0.5 M DMM/1.0 M methanol aqueous solution (i.e. 0.5 moles of dimethyoxymethane per mole of methanol); and a 1.5 M aqueous DMM solution. As in FIG. 3, the x-axis shows current density expressed in milliamperes per square centimeter. The left y-axis expresses stack voltage in volts and the right y-axis expresses stack power in watts.

The performance of the DLFFC stack employing the 1.5 M DMM fuel stream compares favorably to that of the DLFFC stack employing the 1.5 M methanol fuel stream, although the performance is generally slightly poorer for the DMM fuel stream. However, as shown in FIG. 4, the DLFFC stack employing either of the binary fuel mixtures (i.e., either the 1.0 M DMM/0.5 M methanol aqueous solution or the 0.5 M DMM/1.0 M methanol aqueous solution) outperformed the DLFFC employing the 1.5 M methanol fuel stream, particularly at higher current densities (i.e., greater than 200 mA/cm²).

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of operating a fuel cell having a cathode, an anode and an electrolyte, the method comprising supplying a mixture of dimethoxymethane, methanol and water to the anode.

2. The method of claim 1 wherein the fuel cell is a solid polymer fuel cell and the electrolyte comprises a proton exchange membrane.

3. The method of claim 1 wherein the mixture is a liquid.

4. The method of claim 1 wherein the mixture comprises a sufficient amount of dimethoxymethane to render the mixture detectable by its odor.

5. The method of claim 1 wherein the mixture comprises 0.2 moles to 4 moles of methanol per liter of water and 0.05 moles to 15 moles of dimethoxymethane per mole of methanol.

6. The method of claim 1 wherein the mixture comprises 0.3 moles to 1.5 moles of methanol per liter of water and 0.2 moles to 4 moles of dimethoxymethane per mole of methanol.

7. The method of claim 1 wherein the mixture comprises 0.5 moles to 1 mole of methanol per liter of water and 0.5 moles to 2 moles of dimethoxymethane per mole of methanol.

8. The method of claim 1 wherein the fuel cell is operated at a current density of greater than about 200 mA/cm².

9. The method of claim 1, further comprising re-circulating dimethoxymethane, methanol and water from an anode exhaust of the fuel cell into the mixture.

10. The method of claim 1, further comprising re-circulating dimethoxymethane, methanol and water from a cathode exhaust of the fuel cell into the mixture.

11. A fuel cell system comprising a fuel cell having a cathode, an anode and an electrolyte, wherein the anode is supplied with a mixture of dimethoxymethane, methanol and water.

12. The fuel cell system of claim 11, further comprising a mixing apparatus, wherein an outlet of the mixing apparatus is fluidly connected to the anode and inlets of the mixing apparatus are fluidly connected to supplies of dimethoxymethane, methanol and water.

13. The fuel cell system of claim 12 wherein a supply of dimethoxymethane and methanol is fluidly connected to a first inlet of the mixing apparatus.

14. The fuel cell system of claim 12, further comprising a re-circulation loop fluidly connecting an electrode exhaust of the fuel cell to a second inlet of the mixing apparatus.

15. The fuel cell system of claim 14 wherein the re-circulation loop fluidly connects a cathode exhaust of the fuel cell to the second inlet of the mixing apparatus.

16. The fuel cell system of claim 14 wherein the re-circulation loop fluidly connects an anode exhaust of the fuel cell to the second inlet of the mixing apparatus.

17. The fuel cell system of claim 14, further comprising a sensor adapted to detect the composition of the mixture.

18. The fuel cell system of claim 14 wherein the re-circulation loop further comprises a heat exchanger.

19. The fuel cell system of claim 11 wherein the fuel cell is a solid polymer fuel cell and the electrolyte comprises a proton exchange membrane.

20. The fuel cell system of claim 11 wherein the fuel stream is a liquid.

21. The fuel cell system of claim 11 wherein the fuel stream comprises 0.2 moles to 4 moles of methanol per liter of water and 0.05 moles to 15 moles of dimethoxymethane per mole of methanol.

22. The fuel cell system of claim 11 wherein the fuel stream comprises 0.3 moles to 1.5 moles of methanol per liter of water and 0.2 moles to 4 moles of dimethoxymethane per mole of methanol.

23. The fuel cell system of claim 11 wherein the fuel stream comprises 0.5 moles to 1 mole of methanol per liter of water and 0.5 moles to 2 moles of dimethoxymethane per mole of methanol.

24. The fuel cell system of claim 11 wherein the fuel cell is operated at a current density of greater than about 200 mA/cm².
